(19) United States
(12) Patent Application Publication
(10) Pub. No.: US 2013/0318878 A1
(43) Pub. Date: Dec. 5, 2013

(54) DEVICE FOR OPENING AND CLOSING A DOOR AND METHOD INSTALLING SUCH A DEVICE

(71) Applicant: Friedrich Nikolaus Manseder, Wien (AT)

(72) Inventor: Friedrich Nikolaus Manseder, Wien (AT)

(73) Assignee: ABOTIC GMBH, Wien (AT)

(21) Appl. No.: 14/000,549

(22) PCT Filed: Feb. 15, 2012
(86) PCT No.: PCT/AT2012/000029

§ 371 Date: Aug. 20, 2013

(30) Foreign Application Priority Data
Feb. 28, 2011 (AT) A 263/2011

(51) Int. Cl. E05F 15/10

(52) U.S. Cl. CPC E05F 15/10
USPC 49/358

(57) ABSTRACT

A device for opening and closing a door is provided, with a rolling device having a shell-shaped housing assembled from two complementary housing parts and in which a driving device is arranged, which is connected via a drive shaft to a driving wheel which, in a fitted operating position of the rolling device, is in frictional contact with a rolling surface facing the driving wheel. A fixing body is arranged on a housing part, which together with an opposite fixing body on the other housing part, form a fixed bearing for the drive shaft, each fixing body further having a recess forming a bearing seat for a bearing of the drive shaft. A housing part has linear guide means for connection to corresponding linear guide means of a fastening element. The linear guide means are arranged adjacent to the bearing seat. A method for installing such a device is also provided.

The invention relates to an apparatus for opening or closing a door, comprising a rolling device provided to be mounted on the door or in an area adjacent to the door, which comprises a tray-shaped housing composed of at least two complementary housing parts, in which a drive unit is arranged, which is connected via a drive shaft to a drive wheel which, in an assembled operating position of the rolling device, is in frictional contact with a rolling surface facing the drive wheel.

Furthermore, the invention relates to a method for assembling a rolling device provided to be mounted on a door or in an area adjacent to the door for opening or closing the door, whereby a drive unit is assembled or provided in the pre-assembled state, which is connected via a drive shaft to a drive wheel which, in an assembled operating position of the rolling device, is in frictional contact with a rolling surface facing the wheel, and the drive unit is arranged in a tray-shaped-housing composed of at least two complementary housing parts.

From AT 508 228 A1 there is known such an apparatus for automatically opening or closing a door, which can make a significant contribution to a barrier-free furnishing of living areas. The apparatus comprises a two-piece housing accommodating a drive unit. The drive unit comprises an electric motor driving a drive wheel rolling on the floor. The electric motor is powered by a rechargeable storage battery.

The known apparatuses of this type, however, have the disadvantage of the housing being provided with comparatively complicated fixing means for fixing the drivetrain. Therefore, the known embodiments not only result in higher manufacturing costs but also require a complex assembly, which likewise raises the costs of the apparatus.

Another disadvantage of the known apparatuses is that vibrations occur during operation, which, on the one hand, may cause disturbing noises and, in addition, impair the stability of the door opener.

WO 2004/035977 A1 further discloses a different door opener for a swing-wing comprising a housing consisting of a bottom tray and a top tray, wherein a gear output shaft is accommodated, which is guided out of the housing. In addition, retainers for fixing the driving elements are provided. The door closer, however, includes neither a drive wheel nor a slidable support for the housing.

Moreover, from GB 2,085,960 A and U.S. Pat. no. 1,694,431 A slidably supported rolling devices are known.

In comparison thereto, the object of the present invention consists in providing a constructively simple apparatus of the above-mentioned type, which in terms of supporting the drive shaft in the housing is simplified, whereby a movable support of the rolling device comprising a stable and low-vibration arrangement of drive components is to be provided. In addition, a corresponding method of the above-given type resulting in a time-saving and simple assembly of such a rolling device is to be provided.

Said object is solved by an apparatus of the above type, wherein a fixing element is arranged on a housing part co-acting with an opposite fixing element provided on the other housing part in an assembled state of the housing parts such that the co-acting fixing elements form a fixed bearing for the drive shaft, whereby the fixing elements each comprise at least one recess, which in the assembled state of the housing part form at least one bearing seat for at least one bearing of the drive shaft of the drive wheel, whereby a housing part comprises linear guiding means to be connected with corresponding linear guiding means of a fixing element provided to be fastened to a door, whereby the linear guiding means of the housing part are arranged adjacent to the bearing seat of the bearing of the drive shaft.

According to this, fixing elements designed in a complementary fashion are arranged in the interior of the housing for providing the fixed bearing of the drive shaft, which support the drive shaft in the assembled state such that a rotation of the drive shaft is possible, however, the drive shaft not being able to perform a translatory motion. The fixing elements are preferably designed essentially in a semi-tray-shaped manner, so that the drive unit can also be inserted in a recess of the one fixing element, prior to the drive shaft being secured in its final position by means of arranging the other housing part with the complementary fixing element. Thus, the fixing elements can additionally be designed to fix the drive unit in the housing during the assembly of the housing parts. Depending on the design of the rolling device, the opposite fixing elements can be configured so as to be essentially identical semi-trays; in many cases, however, an asymmetrical design of the complementary fixing elements is preferred. The arrangement of the complementary fixing element on the housing parts facilitates, in particular, the adjustment and fixing of the drive shaft in the housing, thus allowing the rolling device to be assembled easier and faster. The fixing elements further enable a retention of the position of the drive shaft in the housing of the rolling device, which is especially reliable during continuous operation, thus reducing maintenance and repair work. When needed, the rolling device can be taken apart and assembled again in a fast and uncomplicated manner. In addition, no further connecting or fixing means for the positional fixing of the drive shaft are basically needed, so that a component-saving and thus cost-efficient apparatus can be obtained. The fixing elements have at least one recess each. Thus, the drive shaft or a bearing element being in connection with the drive shaft can advantageously be inserted in the recess, whereby a fixed support of the drive shaft can be achieved in an especially simple way. For the stable support of the drive shaft in the housing, in the assembled state of the housing parts, the recesses form at least one bearing seat for at least one bearing of the drive shaft, which is designed in accordance with the outer ring of a ball bearing provided as bearing; preferably, two bearing seats spaced apart from each other are provided. For this purpose, it is favorable if the recesses have an essentially circular portion in the assembled state of the housing parts, in which portion the bearing connected to the drive shaft of the drive wheel, expediently an outer ring of a ball bearing is arranged. A bearing seat for supporting corresponding bearings of the drive shaft is provided preferably on both sides of the drive shaft. To support the rolling device in a movable way, one housing part comprises linear guiding means to be connected with corresponding linear guiding means of a fixing element provided to be fastened to a door. Thereby, when mounted on the door, the rolling device can be guided along a floor or bottom structure. For designing the linear guide, the housing expediently comprises at least one guide carriage which includes a holding groove for a corresponding guide bar on a plate-shaped fixing element. Of course, a reversed arrangement of guide carriage and guide bar on the fixing element or on the housing would also be conceivable. With respect to a stable, low-vibration arrangement, the linear guiding means of the housing part are arranged adjacent to the bearing seat for the bearing of the drive shaft. In a preferred embodiment, bearing seats realized on both sides of the drive wheel are each arranged adjacent to linear guiding means on the housing.

The recesses of the fixing elements, in the assembled state of the housing parts, preferably comprise a portion for accommodating a drive, in particular an electric motor, preferably a geared electric motor. In accordance with an outer housing of the drive, the portion for accommodating the drive may have in particular an essentially rectangular cross-section. In an alternative embodiment, the drive is fixed in a recess (of essentially any shape) by an intermediate layer of an insulating material.

To reliably fix the drive unit in axial direction, it is favorable if the fixing element comprises a projection projecting into the recess or limiting the recess. The projection projecting into the recess is preferably arranged between adjacent components of the drive unit. The adjacent drive components can thereby be secured against a shifting in axial direction, i. e. in particular in the longitudinal direction of the drive shaft. Another projection can limit the recess on one side. In an especially preferred embodiment, drive shaft bearings arranged on both sides of the drive wheel each have one side in contact with a projection of the fixing element, so that the drive shaft bearings are fixed between the projections of the fixing elements in axial direction.

To transmit the torque of the drive unit onto the rolling surface, it is advantageous if the housing parts form a recess which with respect to the mounted operating position of the rolling device is open towards the rolling surface, projecting through which recess is the drive wheel. The drive wheel is expediently at least partially accommodated in the interior of the housing, whereby the bearings of the drive wheel can be protected from soiling, damage, etc.; the drive wheel extends on its circumference beyond the plane of the respective housing wall to contact the pertinent rolling surface, in particular a bottom surface in the mounted operating position.

With respect to a cost-efficient series production, the fixing element is preferably made of a plastic material, preferably an acrylonitrile-butadiene styrene, polycarbonate, polyamide or polypropylene or a two-component plastic material.

A particularly preferred embodiment of the invention provides for the fixing element to be integrally designed with the respective housing part. Therefore, the fixing elements constitute integral components of the housing. During assembly, thus preferably the adjustment of the fixing element relative to the pertinent housing parts of the rolling device can be omitted, which in conventional door openers has turned out to be complex. In addition, an especially stable, fixed support of the drive shaft in the housing is achieved, reliably withstanding any loads occurring during continuous use.

For designing the housing part and the fixing element positioned therein, it is favorable to provide an injection-moulded part. The injection moulding method allows a cost-efficient series production of the housing parts. In addition, the fixing elements can be positioned with a high degree of accuracy in the housing, since any subsequent fixing or adjustment of the fixing elements relative to the housing parts is omitted. Thus, the fixing of the drive unit in the mounted state of the rolling device can be improved. In an alternative embodiment, it would be conceivable to manufacture the housing parts for the integral design of the fixing elements in a casting method.

In addition, the object on which the invention is based is solved by means of a method, wherein the drive shaft is positioned between the two housing parts, so that a fixing element arranged on a housing part co-acts with an opposite fixing element arranged on the other housing part such that the co-acting fixing elements form a fixed bearing for the drive shaft, whereby the fixing elements each comprise at least one recess, which in the assembled state of the housing part form at least one bearing seat for at least one bearing of the drive shaft of the drive wheel, whereby a housing part comprises linear guiding means to connect with corresponding linear guiding means of a fixing element provided to be connected with a door, whereby the linear guiding means of the housing part are arranged adjacent to the bearing seat of the bearing of the drive shaft.

Therefore, in order to assemble the rolling device, it is only necessary to arrange the drive shaft between the fixing elements and finally connect the housing parts to one another, preferably after having assembled the drive unit including the drive shaft, which can also be provided in the pre-assembled state. During the assembly of the housing parts, the drive shaft is supported by the fixing elements such that a position-safe arrangement of the drive shaft in the housing is obtained. Thus, assembly of the rolling device may be carried out easier and faster, since the support of the drive shaft can be fixed in the desired position, without further adjustment or fixing upon closing of the door. Depending on the design of the rolling device, the drive unit may additionally be connected via a supply or data line to a control device, which is possibly fixed to a housing part by separate fixing means (e. g. with a bolted or riveted joint), prior to the housing parts being assembled.

The invention will now be described in more detail in a non-limiting way, on the basis of exemplary embodiments shown in the drawings.

The following will be shown in detail in the drawings:

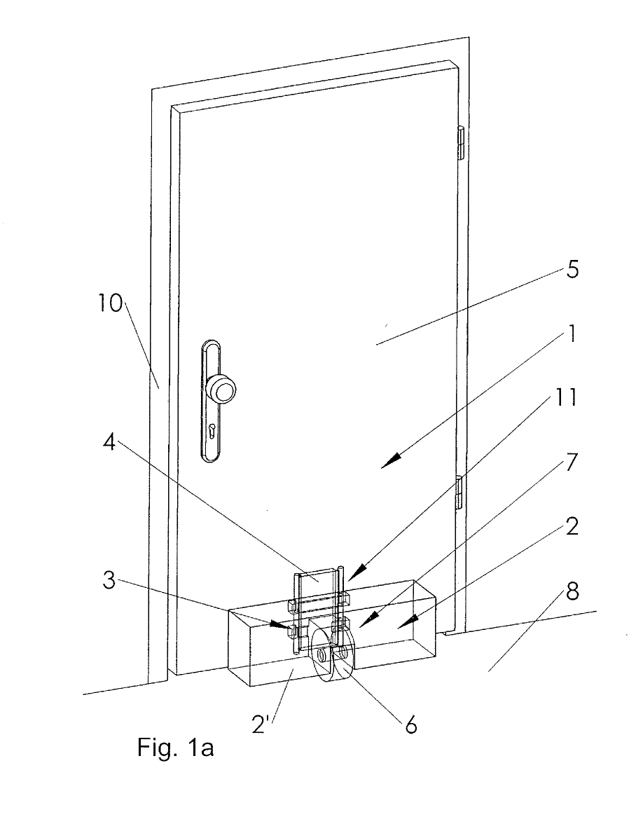

FIG. 1a is a schematic view of a rolling device according to the invention, which in accordance to a first embodiment is mounted on a pivotable door;

FIG. 1b is a schematic view of a further rolling device according to the invention, which in accordance with an alternative embodiment for opening or closing a sliding door is positioned in the area of a door frame;

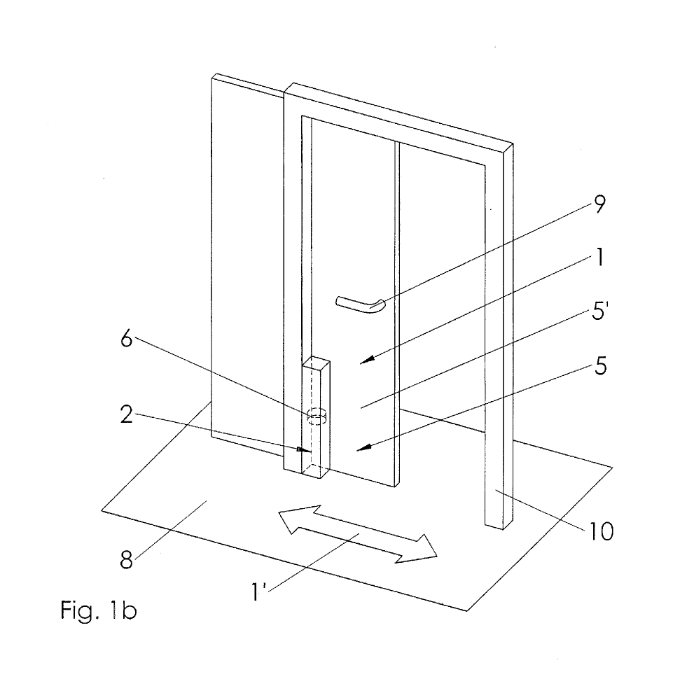

FIG. 2a and FIG. 2b are each diagram views of an embodiment of the rolling device according to FIG. 1a, which comprises a multi-piece housing for accommodating a drive unit;

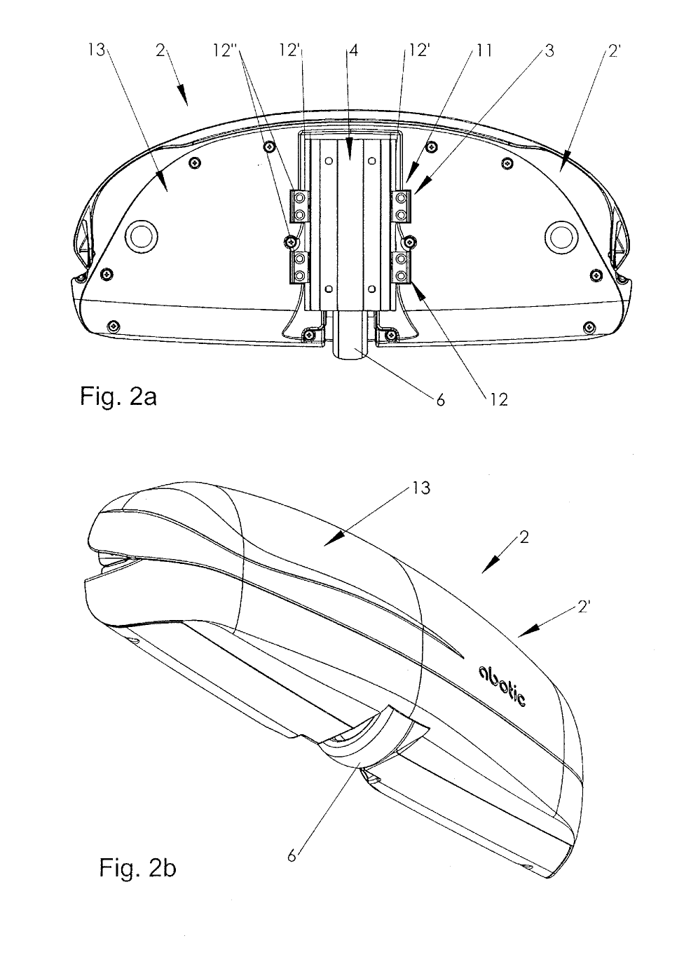

FIG. 3 is a schematic view of a rolling device designed according to FIG. 1 or FIG. 2, which in the non-assembled state of the housing parts is shown with a separate drive unit;

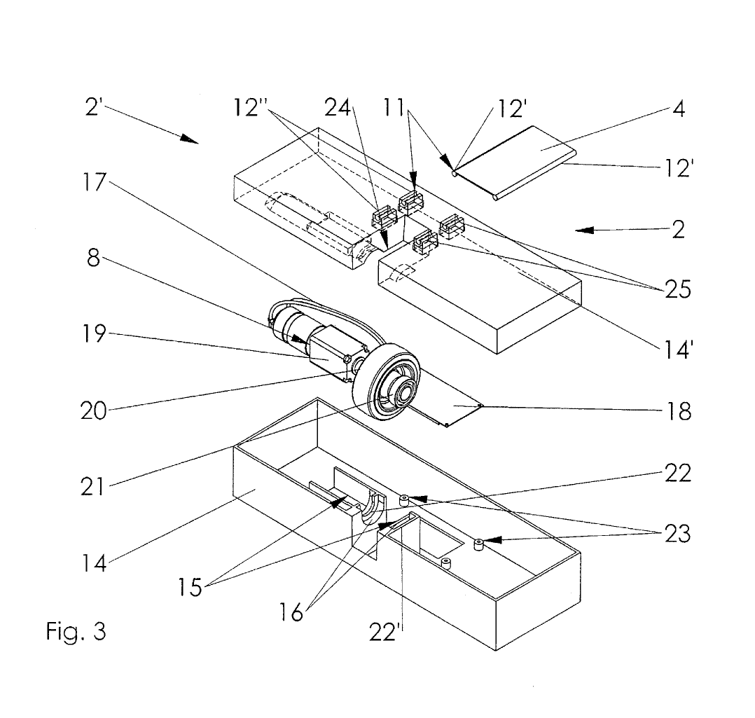

FIG. 4 is a schematic view of the rolling device according to FIG. 3, after the drive unit has been inserted in a recess of a semi-tray-shaped fixing element on one of the housing parts;

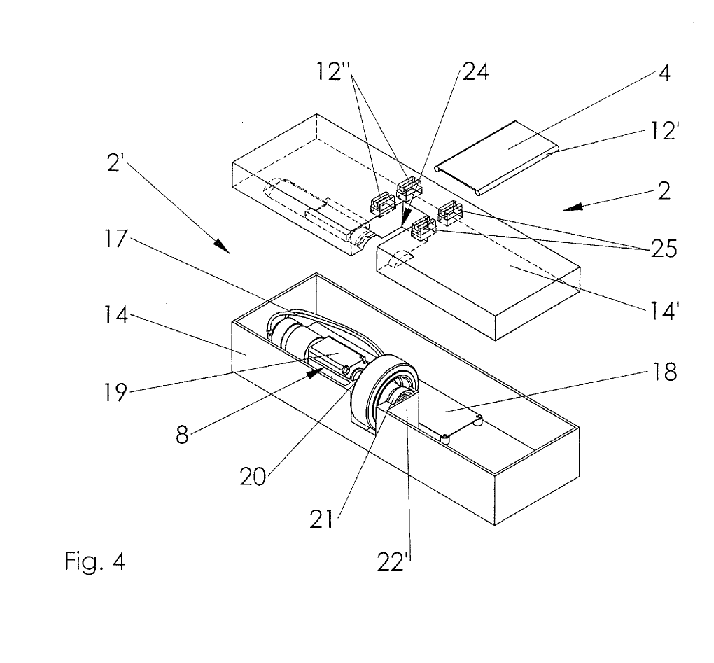

FIG. 5a is a sectional view of the rolling device according to FIG. 3 in the area of a bearing of the drive shaft of the drive unit;

FIG. 5b is a sectional view of the rolling device according to FIG. 5a in the assembled state of the housing parts;

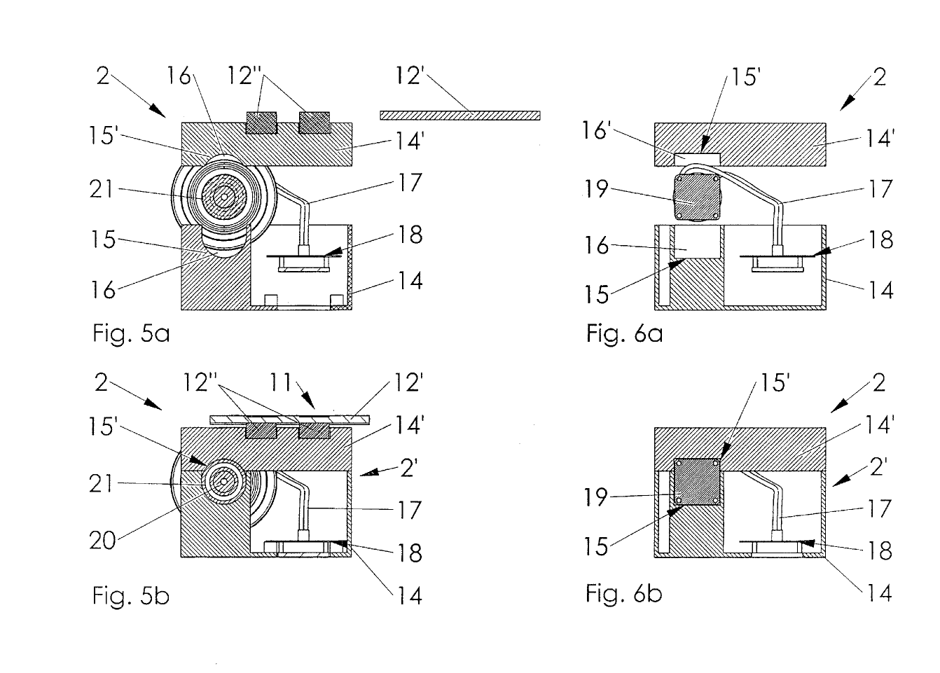

FIG. 6a is a sectional view of the rolling device according to FIG. 3 in the area of a drive of the drive unit; and

FIG. 6b is a sectional view of the rolling device according to FIG. 6a in the assembled state of the housing parts.

In FIG. 1a, a pivotably supported door 1 is shown, whereby a rolling device 2′ of an apparatus 2 for the selective automatic opening or closing of the door 1 is arranged in the bottom area of the door 1. The rolling device 2′ comprises a connecting element 3 detachably mounted on a fixing member 4 which is fixed to a door leaf 5 of the door 1 in particular by means of a threaded joint or glued joint. The rolling device 2′ comprises a drive wheel 6 which can be driven via a drive unit 7 (shown in FIGS. 3 to 6). In the driven state, the drive wheel 6 transmits a torque onto the bottom surface 8 adjacent to the door leaf 5 of the door, which surface constitutes the rolling surface of the drive wheel 6 in the embodiment shown in FIG. 1a. When automatically opening or closing the door 1 by means of driving the drive wheel 6, the door leaf 5 is swiveled about its swivel axis. In addition, the rolling device 2′ can have an interface (not shown in the figures) which is adapted for the communication with especially radio-controlled control devices. For instance, remote controls, proximity sensors, etc. can be provided as control devices to automatically initiate an opening or closing operation in the case of a person approaching or moving away.

FIG. 1b schematically shows an alternative embodiment comprising door 1 that can be linearly moved in the direction of arrow 1′ and includes a door handle 9, wherein the rolling device 2 is arranged in an area adjacent to the door leaf 5, here a door frame 10. The drive wheel 6 of the rolling device 2′ is in frictional contact with a surface 5′ of the door leaf 5 forming the rolling surface, so that in the driven state of the drive wheel 6 a torque can be transmitted onto the door leaf 5, which causes the door 1 to be moved into the opening or closing position.

FIGS. 2a and 2b show a rear view and a front view, respectively, of an apparatus 2 designed according to FIG. 1a for opening or closing the pivotable door 1. So as to guarantee the frictional contact between the drive wheel 6 and the bottom surface 8 the rolling device 2′ is supported so as to be movable essentially perpendicular to the direction of movement of the opening or closing process, under the influence of its own weight. A linear sliding bearing 11 is provided therefor between the connecting element 3 of the rolling device 2′ and the connecting member 4 that can be mounted to the door 1, which bearing comprises linear guiding means 12 slidable against each other. In the shown embodiment, the plate-shaped connecting member 4 comprises two lateral guide bars 12′ which are each slidably connected with two guide carriages 12″ which are distanced in vertical direction and provided on the housing part 14′ (cf. FIG. 3).

As can be seen from FIGS. 3 to 6, the rolling device 2′ comprises a housing 13 which is composed of at least two complementary housing parts 14, 14′, which in the assembled state enclose a cavity which is provided to accommodate the drive unit 8 of the rolling device 2′. According to FIGS. 3 to 6, the housing parts 14, 14′ are essentially designed as semi-trays or halves of the housing 13, whereby the housing part 14′ in the shown embodiment has a lower height than the opposite housing part 14. Of course, it would also be conceivable that each housing part 14, 14′ consists of two or more parts connected to each other in a suitable manner.

So far, a comparatively complicated internal construction has been provided in known rolling devices 2′ to fix the drive unit 8 in the housing 13. In comparison, the rolling device 2′ according to the invention allows a substantially simplified assembly, as will be explained below with reference to FIGS. 3 to 6.

As shown in FIG. 3, a semi-tray-shaped fixing element 15 comprising a recess 16 is arranged on the housing part 14. The semi-tray-shaped fixing element 15 is complementary to an opposite semi-tray-shaped fixing element 15′ arranged on the other housing part 14′, which comprises a recess 16′ matching the recess 16.

As is further shown by FIG. 3, the housing parts 14, 14′ are available in the non-assembled state, i. e. separately from each other at the beginning of the assembly. In addition, a pre-mounted drive unit 8 is provided, which is connected to a control device 18 via schematically shown supply or data lines 17. The drive unit 8 comprises a drive 19 which is connected to a drive shaft 20 supporting the drive wheel 6. An electric motor 19 is preferably provided as drive 19, which can have a coupling (not shown) or a step-down gear (not shown). The drive 19 is powered via an energy storage, in particular a rechargeable battery. Alternatively, a battery can be provided as energy storage, whose advantage over the accumulator lies in its lower tendency to self-discharge. Therefore, the use of batteries is to be preferred especially if the apparatus is operated at irregular intervals only, e. g. in a vacation home. For the support of the drive shaft 20, a bearing 21, preferably a roller bearing is provided on the side of drive wheel 6 opposite of the drive 19. In addition, a further bearing, preferably a roller bearing (not shown in the figures) connected to the drive shaft 20 is provided on the side of the drive 19.

As is further shown in FIG. 3, the fixing element 15 or 15′ is designed integrally with the pertinent housing part 14 or 14′. The recesses 16, 16′ essentially constitute the negative form of the drive unit 8; however, the recesses 16, 16′, may also be larger than or have a shape deviating from the housing of the drive unit 8, the clearance preferably being filled with an insulating material. The housing parts 14, 14′ are expediently designed as injection-moulded parts which are injection-moulded from a suitable plastic material, expediently acrylonitrile-butadiene styrene or polypropylene. Advantageously, different wall thicknesses can be produced thereby in the injection moulding method, preferably in the propellant gas injection moulding method, so that the fixing elements 15, 15′ have a wall thickness of about 10 to 16 mm for the purpose of a stable support; the non-supporting housing parts 14, 14′, on the other hand, have a wall thickness of about 3 to 4 mm only.

As may further be seen from FIG. 3, the recesses 16, 16′ of the fixing elements 15, 15′ comprise portions with different cross-sectional geometries, which are essentially designed in accordance with the components of the drive unit 8 to be accommodated therein (or according to an outer housing of these drive components), as will be further illustrated with reference to FIGS. 5, 6.

As may further be seen from FIG. 3, the fixing element 15 comprises a curved projection 22 projecting into the recess 16, which is arranged between the drive wheel 6 and the drive 9 in the assembled state of the housing parts 14, 14′ (cf. FIG. 4). The opposite fixing element 15′ has a complementary, curved projection. A wall-shaped projection 22′ limiting the recess 16 is provided on the opposite side of the drive wheel 6, so that the drive shaft bearings 21 are fixed between the projections 22, 22′ in axial direction.

As may be seen from FIG. 4, the bearings 21 of the drive shaft 20 are inserted in the appropriate recesses 16 of the semi-tray-shaped fixing element 15. Subsequently, the control device 18 is fixed on the housing part 14 by connecting means 23 drawn schematically.

Having inserted the drive shaft 20 including the drive unit 8 in the fixing element 15 and fixed the control device 18 on the housing part 14, the housing part 14′ is connected to the housing part 14. A lock-type, snap-type or bolted connection (not shown) can be provided for the detachable connection of the housing parts 14, 14′. When assembling the housing parts 14, 14′, the bearings 21 and thus the drive shaft 20 of the drive unit 8 are automatically held in position in the recesses 16, 16′ of the semi-tray-shaped fixing elements 15, 15′, i. e. they are secured in their position in such a manner that no other arrangements must be made to hold the drive shaft 20 and thus the entire drive unit 8 in position.

As may be further gathered from FIGS. 3 and 4, the drive wheel 6 is arranged in a recess 24 of the housing parts 14, 14′, in the assembled state of the housing 13. The recess 24 is realized on the housing part 14′ in a manner open towards the rolling surface. In the assembled state of the housing parts 14, 14′, the drive wheel 6 extends through the recess 19, whereby the drive wheel 6 rests on the rolling surface in the assembled operating position of the rolling device 2′.

As can be seen from FIGS. 5a and 5b, the fixing elements 15, 15′ comprise portions which are shaped in accordance with the bearings 21 of the drive shaft 20, which portions form bearing seats for the bearings 21 located adjacent to the drive wheel 6. In the assembled state of the housing parts 14, 14′, which are shown in FIG. 5b, the recesses 16, 16″ of the fixing elements 15, 15′ altogether have an essentially circular cross-section in the area of the bearing 21. In the embodiment shown in FIGS. 3 to 6, the recess 16 of the fixing element 15—according to the different height of the housing parts 14, 14′—has a larger depth than the opposite recess 16′ of the fixing element 15′. So as to enable insertion of the bearing 21 without deforming the adjacent wall portions of the fixing element 15, the recess 16 of the fixing element 15 has a U-shaped cross-section; the opposite recess 16′ has a complementary cross-section in the shape of the segment of a circle.

As can also be seen from FIGS. 5a and 5b, the linear guiding means 12′, 12″ of the linear guide 11 are arranged adjacent to the portions of the recesses 16, 16′ forming the bearing seats to thus avoid any vibrations during operation. Due to the bearing seats and the linear guide being arranged in an adjacent position, the result is also a stable design of the rolling device 2′, i.e. a design which is insensitive to shocks resulting, for instance, from the crash of a wheel chair or the kick of a foot. When the two bearings are arranged in a non-adjacent manner, consequently all elements afflicted by shock would have to be designed in a sturdier way in order to increase stability, which [as a result] would be of disadvantage.

As can be seen from FIGS. 6a and 6b, the recesses 16, 16′ of the fixing elements 15, 15′ have a portion shaped in accordance with the drive 19. In the assembled state of the housing parts 14, 14′ according to FIG. 6b, the drive 19 is arranged in a position- and rotation-prove manner, in the pertinent portion of the recesses 16, 16′ which have an essentially rectangular cross-sectional shape. In accordance with the asymmetrical design of the housing parts 14, 14′ (or the fixing elements 15, 15′), a major part of the drive 19 is arranged in the comparatively deep recess 16 of the fixing element 15. Alternatively, the recesses 16, 16′ may be adapted in the area of the drive 19 also not for the positive accommodation of a housing of the drive 19, in which case an insulating material is expediently arranged in the space.

1. An apparatus for opening or closing a door, comprising a rolling device provided to be mounted on the door or in an area adjacent to the door, which comprises a tray-shaped housing composed of at least two complementary housing parts, in which a drive unit is arranged, which is connected via a drive shaft to a drive wheel which, in an assembled operating position of the rolling device, is in frictional contact with a rolling surface facing the drive wheel, wherein a fixing element is provided on a housing part, which co-acts with an opposite fixing element provided on the other housing part in an assembled state of the housing parts such that the co-acting fixing elements form a fixed bearing for the drive shaft supporting the drive wheel, the fixing elements including each at least one recess (16, 16′), which in the assembled state of the housing parts form at least one bearing seat for at least one bearing of the drive shaft of the drive wheel, wherein a housing part, for the slidable support, comprises linear guiding means to be connected with corresponding linear guiding means of a fixing member provided to be fastened to the door, so that, when mounted on a door, the rolling device can be guided along a floor or bottom structure, wherein the linear guiding means of the housing part are arranged adjacent to the bearing seat of the bearing of the drive shaft.

2. The apparatus according to claim 1, wherein two bearing seats distanced from each other are provided.

3. The apparatus according to claim 1, wherein the recesses comprise, in the assembled state of the housing parts, a portion for accommodating a drive, in particular an electric motor, preferably a geared electric motor.

4. The apparatus according to claim 1, wherein the fixing element comprises a projection either projecting into the recess or limiting the recess.

5. The apparatus according to claim 1, wherein the housing parts form a recess which is open towards the rolling surface with respect to the assembled operating position of the rolling device, projecting through which recess is the drive wheel.

6. The apparatus according to claim 1, wherein the fixing element is made of a plastic material.

7. The apparatus according to claim 1, wherein the fixing element is designed integrally with the respective housing part.

8. The apparatus according to claim 7, wherein an injection-moulded member is provided for the housing part and the fixing element arranged therein.

9. A method for assembling a rolling device provided to be mounted on a door or in an area adjacent to the door for opening or closing the door, whereby a drive unit is assembled or provided in a pre-assembled state, which is connected via a drive shaft to a drive wheel which, in an assembled operating position of the rolling device, is in frictional contact with a rolling surface facing the wheel, and the drive unit is arranged in a tray-shaped housing composed of at least two complementary housing parts, wherein the drive shaft is positioned between the two housing parts such that a fixing element mounted on a housing part cooperates with an opposite fixing element provided on the other housing part such that the cooperating fixing elements form a fixed bearing for the drive shaft supporting the drive wheel, the fixing elements including each at least one recess, which, in the assembled state of the housing parts, form at least one bearing seat for at least one bearing of the drive shaft of the drive wheel, whereby a housing part, for the slidable support, comprises linear guiding means to be connected with corresponding linear guiding means of a fixing element provided to be fastened to the door, so that, when mounted on the door, the rolling device can be guided along a ground or bottom structure, wherein the linear guiding means of the housing part are arranged adjacent to the bearing seat of the bearing of the drive shaft.

10. The apparatus according to claim 1, wherein the fixing element is made of a thermoplastic plastic material.

11. The apparatus according to claim 10, wherein the thermoplastic plastic material is selected from the group consisting of acrylonitrile-butadiene styrene, polypropylene, and a two-component plastic material.
